(19) United States
(12) Patent Application Publication
(10) Pub. No.: US 2010/0309371 A1
(43) Pub. Date: Dec. 9, 2010

(54) Method And System For Integrated Video Noise Reduction And De-Interlacing

(76) Inventor: Sheng Zhong, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/477,699

(22) Filed: Jun. 3, 2009

(51) Int. Cl. H04N 7/01; H04N 5/00

(52) U.S. Cl. 348/448; 348/607; 348/E07.03; 348/E05.001

(57) ABSTRACT

A video processing system may include a shared memory, a motion compensated temporal filter (MCTF) and a motion compensated or motion adaptive de-interlacer. The MCTF and/or the de-interlacer may read noise reduced pixel data from the shared memory. The MCTF may estimate motion and/or motion vectors between fields, may determine a method for noise reduction and may send noise reduced pixel data to the shared memory and to the de-interlacer. The de-interlacer may read a current field of noise reduced pixel data from the MCTF and one or more fields from the shared memory. The de-interlacer may estimate motion and/or motion vectors between fields and may write quantized estimated motion to the shared memory. Based on the estimated motion and/or motion vectors, the de-interlacer may determine a method for estimating missing pixel data and may generate new pixel data for the missing pixel data in an interlaced field.

### CROSS-REFERENCE TO RELATED APPLICATIONS/INCORPORATION BY REFERENCE

Not Applicable

### FIELD OF THE INVENTION

Certain embodiments of the invention relate to communications. More specifically, certain embodiments of the invention relate to a method and system for integrated video noise reduction and de-interlacing.

### BACKGROUND OF THE INVENTION

In video systems, an image is presented in a display device, for example in a television, a monitor, a desktop device and/or handheld device. Most video broadcasts, nowadays, utilize video processing applications that enable broadcasting video images in the form of bit streams that comprise information regarding characteristics of the image to be displayed. These video applications may utilize various de-interlacing functions to present content comprising still and/or moving images on a display. For example, de-interlacing functions may be utilized to convert moving and/or still images to a format that is suitable for certain types of display devices that are unable to handle interlaced content.

Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field.

In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for integrated video noise reduction and de-interlacing, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary video processing system, in accordance with an embodiment of the invention.

FIG. 1B is a block diagram illustrating an exemplary sequence of interlaced video fields, in accordance with an embodiment of the invention.

FIG. 1C is a block diagram illustrating exemplary indexing for a sequence of interlaced video fields, in accordance with an embodiment of the invention.

FIG. 2A is a block diagram illustrating an exemplary two field motion compensated temporal filter, in accordance with an embodiment of the invention.

FIG. 2B is a block diagram illustrating an exemplary five field motion adaptive de-interlacer, in accordance with an embodiment of the invention.

FIG. 2C is a block diagram illustrating an exemplary four field motion adaptive de-interlacer, in accordance with an embodiment of the invention.

FIG. 2D is a block diagram illustrating an exemplary configuration for cascading a two field motion compensated temporal filter and a five field motion adaptive de-interlacer, in accordance with an embodiment of the invention.

FIG. 2E is a block diagram illustrating an exemplary configuration for cascading a two field motion compensated temporal filter and a four field motion adaptive de-interlacer, in accordance with an embodiment of the invention.

FIG. 3A is a block diagram illustrating an exemplary four field motion compensated de-interlacer, in accordance with an embodiment of the invention.

FIG. 3B is a block diagram illustrating an exemplary configuration that may enable cascading a two field motion compensated temporal filter and a four field motion compensated de-interlacer, in accordance with an embodiment of the invention.

FIG. 4 illustrates exemplary steps for reducing noise and de-interlacing fields of interlaced video utilizing a shared DRAM, in accordance with an embodiment of the invention.

### DETAILED DESCRIPTION OF THE INVENTION

Certain embodiments of the invention may be found in a method and system for integrated video noise reduction and de-interlacing. In various embodiments of the invention, a video processing system may comprise a motion compensated filter, a de-interlacer and a memory that is shared by the motion compensated filter and de-interlacer. The motion compensated filter may be a motion compensated temporal filter (MCTF). The motion compensated filter and/or the de-interlacer may be operable to read one or more fields of noise reduced pixel data from the shared memory. The de-interlacer may convert a noise reduced current field of pixel data to a de-interlaced frame of pixel data utilizing the one or more fields of noise reduced pixel data read from the shared memory. In this regard, the motion compensated filter may estimate motion between two or more fields of pixel data. Based on the estimated motion, the motion compensated filter may determine a method for replacing noisy pixel data and may generate pixel data to replace the noisy pixel data. Once a current field of pixel data has been noise reduced, the motion compensated filter may communicate the noise reduced current field of pixel data to the shared memory and to the de-interlacer. The de-interlacer may read the current field of noise reduced pixel data and may read one or more fields of noise reduced pixel data from the shared memory. The de-interlacer may estimate motion between two or more fields of noise reduced pixel data based on motion compensated and/or motion adaptive techniques and may write quantized estimated motion to the shared memory. In this regard, motion may be estimated by searching for matching pixel data at one or more displaced positions within one or more of said fields of noise reduced pixel data. Based on the estimated motion, the de-interlacer may determine a method for estimating missing pixel data. The de-interlacer may also read two or more quantized motion estimates from the shared memory. Pixel data that may be missing from the interlaced frame may be generated by the de-interlacer.

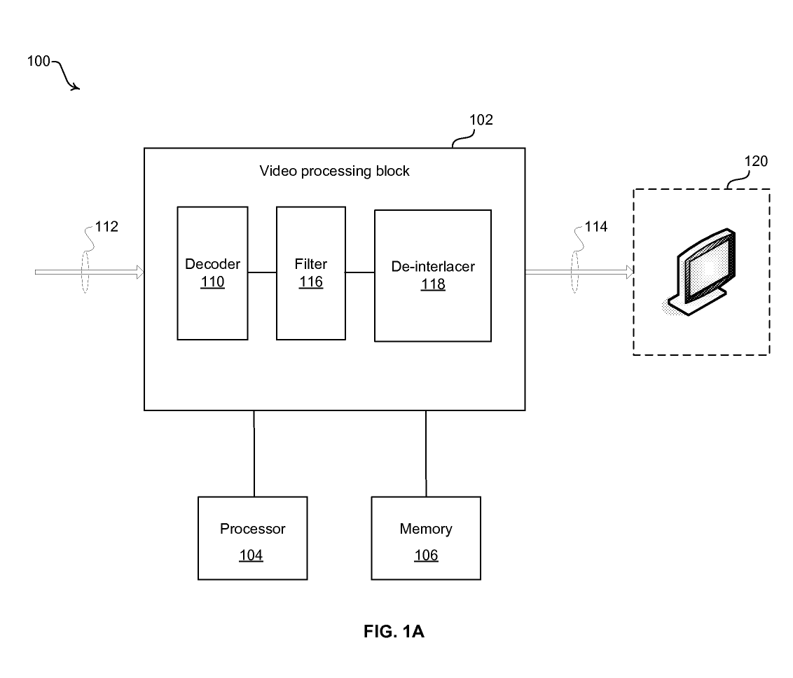

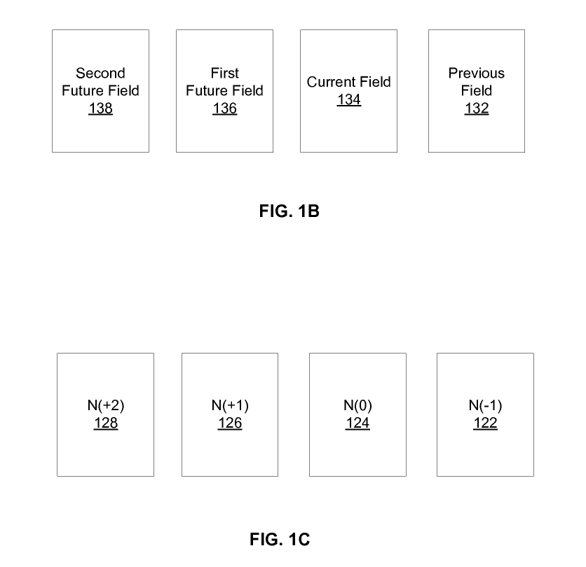

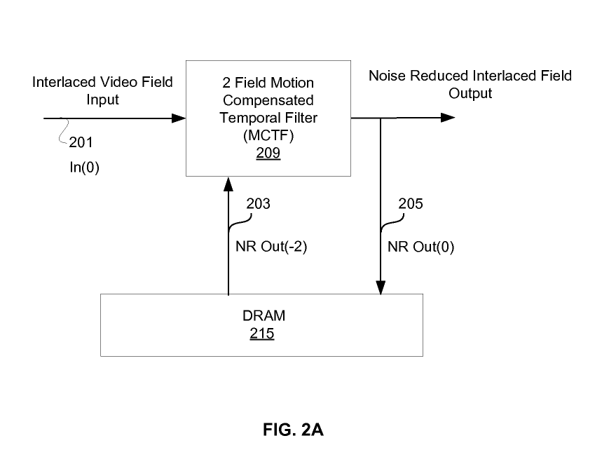

FIG. 1A is a block diagram of an exemplary video processing system, in accordance with an embodiment of the invention. Referring to FIG. 1A, there is shown a video processing system 100, a video processing block 102, a processor 104 and a memory 106. The video processing block 102 may comprise a decoder 110, a filter 116 and a de-interlacer 118.

The input video stream 112 may comprise a data stream comprising video information. The input video stream 112 may comprise, for example, an encoded video stream which may be generated and/or communicated, for example, via television head-ends and/or audio/video playback devices. The output video stream 114 may comprise a stream of video data that may be suitable for processing via display logic, for example in the display subsystem 120.

The video processing block 102 may comprise suitable logic, circuitry, code and/or interface(s) that may be operable to receive an interlaced video stream 112 and reduce noise and/or de-interlace fields within the input video stream 112. Video fields may alternate parity between top fields and bottom fields. Top fields and bottom fields in an interlaced system may be de-interlaced to produce a video frame.

The video processing block 102 may be enabled to receive an interlaced video input stream and, in some instances, to decode the received video input stream. In this regard, the decoder 110 may comprise suitable logic, circuitry, and/or code that may be enabled to perform decompression of the received video fields.

The filter 116 in the video processing block 102 may comprise suitable logic, circuitry, code and/or interface(s) that may be operable to perform filtering operation with noise reduction on a current field. The noise may comprise analog noise that may be introduced into pixel data via a video distribution channel. For example, the noise may occur randomly over time and at different pixel and/or sub-pixel positions within a sequence of interlaced video fields. The filter 116 may be operable to detect motion within the stream of video 112 and may utilize a degree of motion, video content, filter coefficients, threshold levels, and/or constants to generate a filtered video output stream.

The de-interlacer 118 may comprise suitable logic, circuitry, code and/or interface(s) that may be operable to receive interlaced fields of video and output de-interlaced progressive video frames. In this regard, the de-interlacer 118 may be operable to estimate motion between a plurality of video fields and may interpolate missing even lines of pixel data in an odd field and/or interpolate missing odd lines of pixel data in an even field. The de-interlacer 118 may generate progressive video frames that may be displayed at twice the rate as the original scanned interlaced fields. The de-interlacer 118 may be operable to utilize motion adaption and/or motion compensated techniques to aid in interpolation of missing pixel data.

The processor 104 may comprise suitable logic, circuitry, code and/or interface(s) that may be enabled to process data and/or perform system control operations. The processor 104 may be enabled to control at least a portion of the operations of the video processing block 102. Moreover, the processor 104 may be enabled to program, update, and/or modify filter coefficients, threshold levels, and/or constants for the filter 116 and/or the de-interlacer 118.

The memory 106 may comprise suitable logic, circuitry, code and/or interface(s) that may be enabled to store information that may be utilized by the video processing block 102 to reduce noise and/or de-interlace fields of data in the video input stream 112. The memory 106 may be enabled to store instructions and/or configuration data, for example, filter coefficients, threshold levels, and/or constants to be utilized by the video processing block 102. In various embodiments of the invention, the memory 106 may be used to store image data that may be processed and communicated by the processor 104. The memory 106 may also be used for storing code and/or data that may be used by the processor 104. The memory 106 may also be used to store data for other functionalities of the video processing block 102. For example, the memory 106 may store data corresponding to voice and/or data communication.

In operation, the processor 104 may control input of a stream of interlaced video 112 to the video processing block 102. The video processing block 102 may receive the video input stream 112. The video processing block 102 may generate the de-interlaced output video stream 114 after performing decoding operations by the decoder 110, noise reduction filtering by the filter 116 and/or de-interlacing by the de-interlacer 118. In various embodiments of the invention, the filter 116 may utilize motion adaptive processing and/or motion compensation to determine how to filter noise from a video field. Furthermore, the de-interlacer 118 may utilize motion adaptive processing and/or motion compensation to determine how to generate missing pixel data. The output video stream 114 may be sent to the display 120. In some instances, the video output stream may be encoded and/or stored in the memory 106.

FIG. 1B is a block diagram illustrating an exemplary sequence of interlaced video fields, in accordance with an embodiment of the invention. Referring to FIG. 1B, there is shown four fields of interlaced video comprising a previous field 132, a current field 134, a first future field 136 and a second future field 138.

The previous field 132, the current field 134, the first future field 136 and the second future field 138 may comprise a sequence of interlaced video fields that may be scanned, processed and/or displayed in order from previous fields to future fields. The previous field 132 may represent a field that has already been processed. The current field 134 may represent a field that is currently being processed. The first future field 134 may be next in line to be processed followed by the second future field 136. Each of the fields 132,134,136 and 138 may comprise approximately half of a video frame of raster scanned lines of pixel data. For example, the previous field 132 and current field 134 may comprise a pair of odd and even interlaced video fields that together comprise all of the scan lines of a full video frame. Similarly, the first future field 136 and the second future field 138 may also comprise a pair of odd and even interlaced fields that together comprise all of the scan lines for a full video frame. However, odd and even fields are scanned at different times and may not simply be combined to produce a single de-interlaced video frame. The interlaced fields may be de-interlaced by interpolating the missing lines of pixel data in each field. Interpolating the missing lines in an even field may result in a full progressive video frame comprising estimated odd lines.

In operation, the sequence of four interlaced video fields 132, 134, 136 and 138 may be processed by a filter to reduce noise and may be processed by a de-interlacer to generate progressive video frames. The four interlaced video fields 132, 134, 136 and 138 may be read by or into one or more processors and/or processed in sequence order from the previous field 132 to the second future field 138. When a field is input to a processor and/or when a field has been processed, it may be stored in memory and may be read again into the processor for use in assisting the processing other fields.

FIG. 1C is a block diagram illustrating exemplary indexing for a sequence of interlaced video fields, in accordance with an embodiment of the invention. Referring to FIG. 1C, there is shown four fields of interlaced video comprising N(−1) 122, N(0) 124, N(+1) 126 and N(+2) 128.

The four fields of interlaced video N(−1) 122, N(0) 124, N(+1) 126 and N(+2) 128 may be similar or the same as the four fields of interlaced video fields shown in FIG. 1B. The four interlaced fields may be indexed such that N(−1) 122 corresponds to the previous field 102, N(0) corresponds to the current field 104, N(+1) corresponds to the first future field 106 and N(+2) corresponds to the second future field 108.

In operation, the sequence of four interlaced video fields N(−1) 122, N(0) 124, N(+1) 126 and N(+2) 128 may be processed by a filter to reduce noise and may be processed by a de-interlacer to interpolate odd and even lines to produce progressive video frames. The four interlaced video fields may be read by or into one or more processors and/or processed in sequence order from N(−1) 122 to N(+2) 128. When a field is input to a processor and/or is processed and output from the processor, it may be stored in memory. The stored field may be read into the one or more processors and may be utilized to assist in processing other fields.

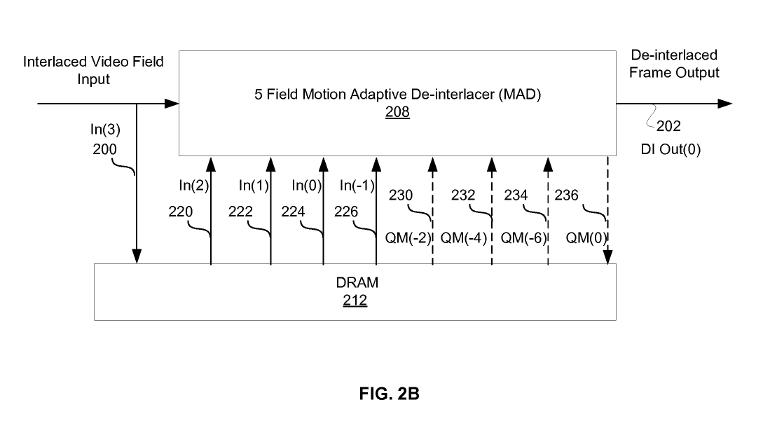

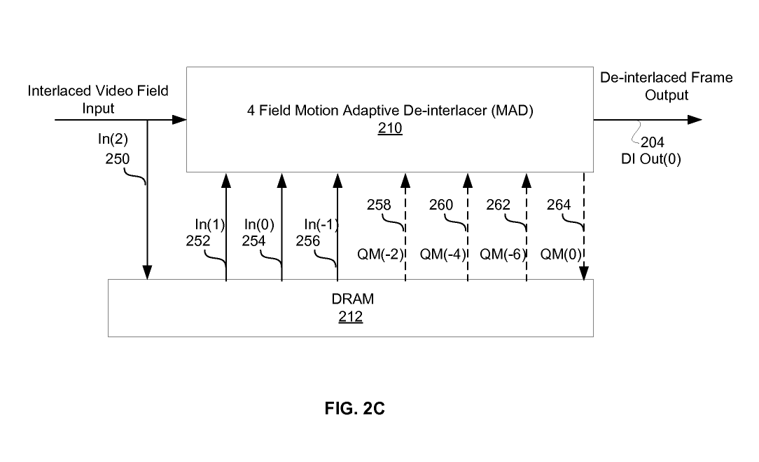

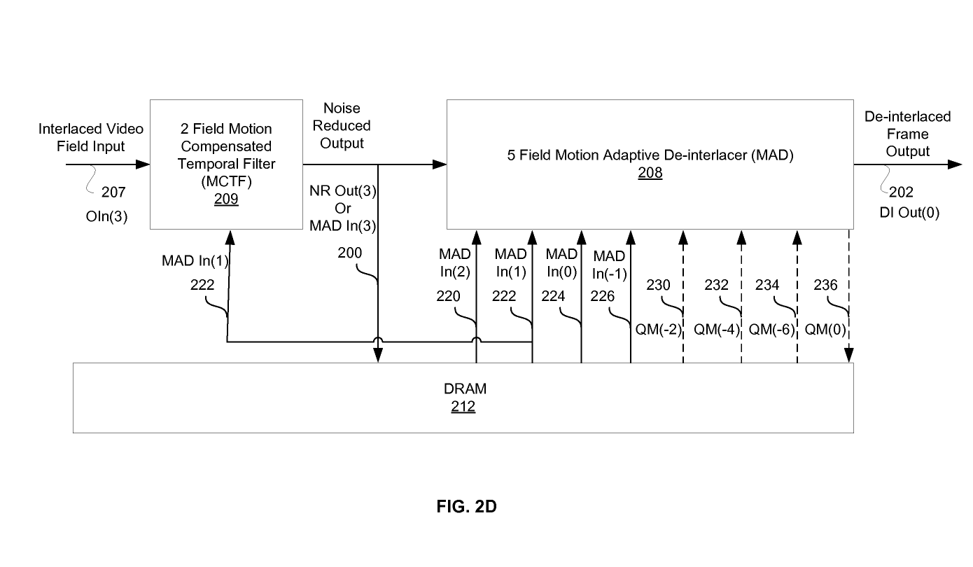

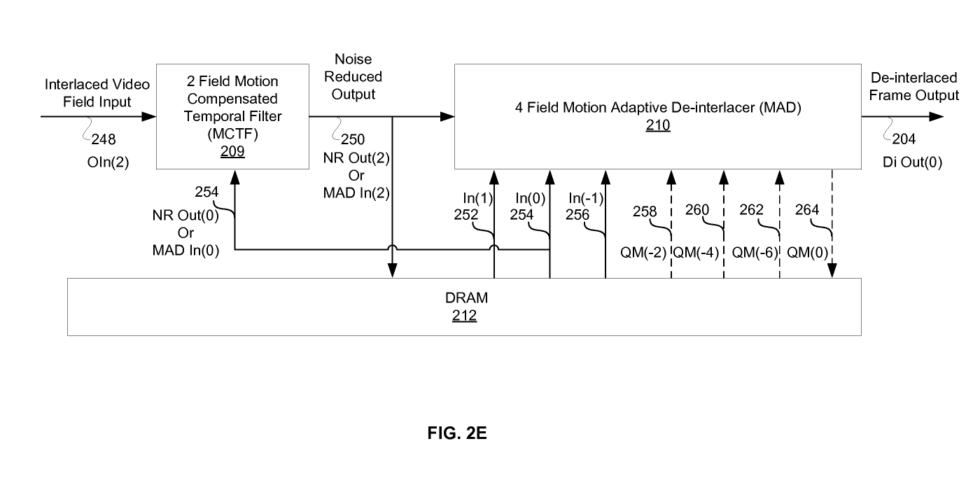

FIG. 2A is a block diagram illustrating an exemplary two field motion compensated temporal filter, in accordance with an embodiment of the invention. Referring to FIG. 2A, there is shown a two field motion compensated temporal filter (MCTF) 209, a dynamic random access memory (DRAM) 215, an input In(0) 201, an output NR Out(0) 205 and a feed back output Out(−2) 203.

The two field motion compensated temporal filter (MCTF) 209 may comprise suitable logic, circuitry, interface(s) and/or code that may be operable to reduce temporally distributed noise and/or spatially distributed noise from one or more interlaced video fields. The noise may comprise analog noise that may be introduced into pixel data via a video distribution channel. For example, the noise may occur randomly over time and at different pixel and/or sub-pixel positions within a sequence of interlaced video fields. The MCTF 209 may be operable to interpolate and/or replace noisy pixel data in a current video field. For example, the MCTF may generate pixel data to replace the noisy pixel data. In some instances, intra-field pixel data that may be located near a noisy pixel may be utilized to generate replacement pixel data, for example, pixel data may be copied or data from a plurality of pixels may be averaged to replace the noisy pixel data. Intra-field pixel data may be utilized, for example, when rapid motion of pixilated imagery is detected between fields in a sequence of fields. In instances when there may be little or no motion or instances when a displacement of pixilated imagery may be known (through motion estimation for example), pixel data from neighboring interlaced fields that are indexed with the same odd or even polarity may be utilized to interpolate pixels. For example, pixel data from the interlaced field N(−2) and/or the field N(+2) may be utilized to interpolate replacement pixel data in the field N(0). In this regard, even numbered scan lines may be processed with other even number scanned lines and odd numbered scan lines may be processed with other odd numbered scan lines. Also in instances of low motion and/or known displacement, collocated or displaced pixel data may be copied from a nearby field of the same odd or even polarity to replace the noisy pixel data. For example, a noisy pixel from the field N(0) may be replaced with a collocated or displaced pixel from the field N(−2). Furthermore, a plurality of collocated and/or displaced pixels from neighboring fields of the same odd or even polarity may be averaged to generate a replacement pixel. In various embodiments of the invention, the MCTF 209 may comprise an infinite impulse response (IIR) filter that may read noise reduced pixel data from a previously output field of the same odd or even polarity to generate replacement pixel data. Although the MCTF 209 is a two field motion compensated temporal filter, the invention is not so limited. For example, various embodiments of the invention may comprise a filter that may utilize one or more other previous and/or future fields to filter out noise. Various embodiments of the invention may also comprise a filter that may utilize a current frame and one or more other previous and/or future frames to filter out noise when the source pictures are progressive; and in this case, it is not necessary for the de-interlacer 118 in FIG.1A to perform de-interlacing. Moreover, exemplary embodiments of the invention may filter noise in a spatial domain and/or may utilize motion adaptive techniques (described with respect to FIG. 2A).

The MCTF 209 may comprise suitable logic, circuitry, interface(s) and/or code that may be operable to provide motion estimation and/or motion compensation. In this regard, the MCTF 209 may be operable to search one or more nearby fields of the same odd or even polarity to estimate a motion of pixelated imagery between the current field and the searched field. The MCTF 209 may determine the direction and/or degree of displacement of the pixelated imagery. The direction and/or degree of motion may be represented by motion vectors. In this regard, the MCTF may determine motion vectors by comparing a reference window of pixel data within a current interlaced field, for example a five by seven window of pixels, with pixel data in a past or future field of same odd or even polarity. The reference window of pixel data may be displaced to various positions within a specified range and may be compared to equally displaced pixel data in the past and/or future fields. If a match is found in a neighboring field, the motion vectors may be determined by the displacement of the reference window at the position of the match. The MCTF may utilize pixel data from a matched window in a future and/or previous interlace field to interpolate noisy pixel data for a reference window of a current field.

The dynamic random access memory (DRAM) 215 may comprise suitable logic, circuitry, interface(s) and/or code that may be operable to store pixel data from one or more fields of interlaced video. The DRAM 215 may be communicatively coupled with the MCTF 209. The DRAM 215 may be operable to store and/or retrieve one or more fields of input data and/or output data from a video processing component during the processing of video fields and/or video frames. For example, the MCTF 209 may be operable to write current output data to the DRAM 215 and may be operable to read stored MCTF 209 output data comprising a previous field of pixel data for each field of pixel data that is processed.

The input In(0) 201 may comprise a field of pixel data that may currently be input and processed by the MCTF 209. The input In(0) 201 may be processed by the MCTF 209 to filter out noise. The output NR Out(0) 205 may be the noise reduced output from the MCTF 209 of the input In(0). The MCTF 209 input NR Out(−2) 203 may be a previous noise reduced output from the MCTF 209 that has the same odd or even polarity as the input In(0) 201 and the output NR Out(0) 205.

In operation, the MCTF 209 may receive a field of interlaced pixel data In(0) 201 and may read a field of interlaced pixel data NR Out(−2) 203 from the DRAM 215. The MCTF 209 may locate noisy pixels in the field In(0) 201. The MCTF 209 may estimate motion between the video fields In(0) 201 and NR Out(−2) 203 by searching with a window of pixel data from In(0) 201 over a range of displacements in the field NR Out(−2) 203. The MCTF may utilize pixel data from collocated and/or displaced pixelated imagery to interpolate and/or replace the noisy pixel in the field In(0) 201. The noise reduced field In(0) 201 may be output from the MCTF 209 as NR out(0) 205.

FIG. 2B is a block diagram illustrating an exemplary five-field motion adaptive de-interlacer, in accordance with an embodiment of the invention. Referring to FIG. 2B, there is shown a five field motion adaptive de-interlacer (MAD) 208, a DRAM 212, an interlaced input field In(3) 200, de-interlacer output frame DI Out(0) 202 and quantized motion QM(0) 236, previous interlaced input fields In(2) 220, In(1) 222, In(0) 224, In(−1) and quantized motion inputs QM(−2) 230, QM(−4) 232, QM(−6) 234.

The five field motion adaptive de-interlacer (MAD) 208 may comprise suitable logic, circuitry and/or code that may be operable to receive interlaced video fields and output de-interlaced progressive video frames. In this regard, the five-field MAD 208 may estimate motion between a plurality of video fields and may interpolate missing even lines of pixel data in an odd field and/or interpolate missing odd lines of pixel data in an even field. The five-field MAD 208 may generate progressive video frames that may be displayed at twice the rate as the scanned interlaced fields. The five-field MAD 208 may estimate motion by comparing odd polarity fields and/or by comparing even polarity fields. In this regard two or more whole fields may be compared and a difference between the fields may be utilized to estimate motion between the fields. A degree of motion may be determined and may be normalized to a value between zero and one, for example. The degree of motion may be utilized to determine a weighting factor for how much information from neighboring fields versus how much information from a current field may be utilized to estimate the missing pixel data. For example, in instances where little motion or no motion is detected between fields, collocated pixels from a neighboring field of opposite odd or even polarity may be copied into the current field. In instances where some motion is detected between fields, a plurality of other fields may be utilized to estimate the interpolated pixels. In instances when rapid motion is detected between fields, intra-field pixels may be averaged or an intra-field pixel may be copied in order to estimate the missing pixel data. In various embodiments of the invention, a linear combination intra-field pixel information and pixel information from one or more other fields may be utilized to estimate missing pixel data.

The DRAM 212 may be similar or substantially the same as the DRAM 215 described with respect to FIG. 2A. The DRAM 212 may comprise suitable logic, circuitry and/or code that may be operable to store pixel data of a plurality of video fields from the five-field MAD 208 and may be operable to retrieve the stored pixel data as needed for de-interlacing processes in the MAD 208.

The video input In(3) 200 may be a field of interlaced video at a specified instant in time. The In(3) 200 field may be input into the five field MAD 208 and also stored in the DRAM 212. The de-interlacer output frame DI Out(0) 202 may be the result of de-interlacing an input In(0). In this regard, the de-interlaced output frame DI Out(0) 202 is delayed by three fields from the input of the interlaced field In(3). In(2) 220, In(1) 222, In(0) 224, and In(−1) are previous inputs to the MAD 208 that were stored in the DRAM 212 at the time of their input into the five field MAD 208 and are read back for assisting in the de-interlacing process for the output frame DI Out(0) 202. The quantized motion information QM(−2) 230, QM(−4) 232 and QM(−6) 234 comprise estimated motion between fields that were previously determined by the MAD 208 and written to the DRAM 212. The quantized motion QM(−2) 230, QM(−4) 232 and QM(−6) 234 are read by the MAD 208 to assist in a de-interlacing process for the output frame DI Out(0) 202. The quantized motion information QM(0) 236 may be determined by the MAD 208 and written to the DRAM 212 for assisting in future processing by the MAD 208. Although the five-field MAD 208 shows a 4-field quantized motion, QM(0) 236, QM(−2) 230, QM(−4) 232 and QM(−6), the invention is not so limited. For example, various embodiments of the invention may comprise a MAD that may utilize fewer or more previous fields of quantized motion.

In operation, the five-field MAD 208 may receive a field of pixel data In(3) 200 and may read four previous inputs In(2) 220, In(1) 222, In(0) 224 and In(−1) 226 from the DRAM 212. The five-field MAD 208 may be operable to estimate motion between two or more of the five input fields In(3) 200, In(2) 220, In(1) 222, In(0) 224 and In(−1) 226 and may determine and/or store the quantized motion information QM(0) 236 in the DRAM 212. In addition, the five field MAD 208 may retrieve the quantized motion information QM(−2) 230, QM(−4) 232 and QM(−6) 234. The five field MAD 208 may utilize the quantized motion information QM(−2) 230, QM(−4) 232, QM(−6) 234 and/or QM(0) 236 to determine a method for interpolating missing pixel data. The five field MAD 208 may be operable to determine missing pixel data and may output the de-interlacer frame DI Out(0) 202.

FIG. 2C is a block diagram illustrating an exemplary four field motion adaptive de-interlacer, in accordance with an embodiment of the invention. Referring to FIG. 2C, there is shown a four field motion adaptive de-interlacer (MAD) 210, the DRAM 212, an interlaced input field In(2) 250, a de-interlaced output frame DI Out(0) 204, three previous interlaced input fields In(1) 252, In(0) 254 and In(−1) 256. In addition, there is shown quantized motion inputs QM(−2) 258, QM(−4) 260, QM(−6) 262 and a quantized motion output QM(0) 264.

The four field motion adaptive de-interlacer (MAD) 210 may comprise suitable logic, circuitry, interface(s) and/or code that may be operable to receive interlaced video fields and output de-interlaced progressive video frames. In various aspects of the invention, the four field MAD 210 may be similar to the five field MAD 210. For example, the four field MAD 210 may be operable to estimate motion between a plurality of video fields and may interpolate missing even lines of pixel data in an odd field and/or interpolate missing odd lines of pixel data in an even field. The four field MAD 210 may be operable to generate progressive video frames that may be displayed at twice the rate as the input scanned interlaced fields. The four field MAD 210 may be operable to estimate motion by comparing odd polarity fields and/or by comparing even polarity fields. In this regard two or more whole fields may be compared and a difference between the fields may be utilized to estimate motion between the fields. A degree of motion may be determined and may be normalized to a value between zero and one, for example. The degree of motion may be utilized to determine a weighting factor for how much information from neighboring fields versus how much information from a current field may be utilized to estimate the missing pixel data. For example, in instances where little motion or no motion is detected between fields, collocated pixels from a neighboring field of opposite odd or even polarity may be copied into the current field. In instances where some motion is detected between fields, a plurality of other fields may be utilized to estimate the interpolated pixels. In instances when rapid motion is detected between fields, intra-field pixels may be averaged to estimate the missing pixel data. In various embodiments of the invention, a linear combination intra-field filtering and interpolation from pixel data in one or more other fields may be utilized to estimate missing pixel data.

The DRAM 212 is described with respect to FIG. 2B.

The interlaced video input In(2) 250 may be a field of interlaced video at a specified instant in time. The interlaced field In(2) 250 may be input into the four field MAD 210 and also stored in the DRAM 212. The de-interlacer output frame DI Out(0) 204 may be the result of de-interlacing an original interlaced input In(0). In this regard, the de-interlaced output frame DI Out(0) 204 may be delayed by two fields from the input of the original interlaced field In(2). The interlaced inputs In(1) 252, In(0) 254, and In(−1) 256 may be previous inputs to the MAD 210 that were stored in the DRAM 212 at the time of their original input into the four field MAD 210. The interlaced inputs In(1) 252, In(0) 254, and In(−1) 256 may be read back into the four field MAD 210 for assisting in the de-interlacing process for the output frame DI Out(0) 204. The quantized motion information QM(−2) 258, QM(−4) 260 and QM(−6) 262 may comprise estimated motion between fields that was previously determined by the MAD 210 and written to the DRAM 212. The quantized motion QM(−2) 258, QM(−4) 260 and QM(−6) 262 may be read by the MAD 210 to assist in a de-interlacing process for the output frame DI Out(0) 204. The quantized motion information QM(0) 264 may be determined by the MAD 210 and written to the DRAM 212 for assisting in future processing by the MAD 210. Although the MAD 210 shows a 4-field quantized motion, QM(0) 236, QM(−2) 230, QM(−4) 232 and QM(−6), the invention is not so limited. For example, various embodiments of the invention may comprise a MAD that may utilize fewer or more previous fields of quantized motion.

In operation, the four field MAD 210 may receive a field of pixel data In(2) 250 and may read three previous inputs In(1) 252, In(0) 254 and In(−1) 256 from the DRAM 212. The four field MAD 210 may estimate motion between two or more of the four input fields In(2) 250, In(1) 252, In(0) 254 and In(−1) 256 and may determine and/or store the quantized motion information QM(0) 264 in the DRAM 212. In addition, the four field MAD 210 may retrieve the quantized motion information QM(−2) 258, QM(−4) 260 and QM(−6) 262. The four field MAD 210 may utilize the quantized motion information QM(−2) 258, QM(−4) 260 and QM(−6) 262 and/or QM(0) 264 to determine a method for interpolating missing pixel data. The four field MAD 210 may determine missing pixel data and may output the de-interlacer frame DI Out(0) 204.

FIG. 2D is a block diagram illustrating an exemplary configuration for cascading a two field motion compensated temporal filter and a five field motion adaptive de-interlacer, in accordance with an embodiment of the invention. Referring to FIG. 2D, there is shown the two field motion compensated temporal filter (MCTF) 209, an original interlaced field input OIn(3) 207 and a noise reduced output field NR Out(3) 200. In addition, there is shown the five field motion adaptive de-interlacer (MAD) 208, the interlaced input fields In(2) 220, In(1) 252, In(0) 224, In(−1) 226, the quantized motion inputs QM(−2) 230, QM(−4) 232, QM(−6) 234, the quantized motion output QM(0) 236 and the de-interlaced frame output DI Out(0) 202. In addition, the DRAM 212 is shown.

The two field motion compensated temporal filter MCTF 209 is described with respect to FIG. 2A. The five field motion adaptive de-interlacer (MAD) 208 is described with respect to FIG. 2B. In addition, the interlaced input fields In(2) 220, In(1) 222, In(0) 224, In(−1) 226 which may be read from the DRAM 212, the quantized motion inputs QM(−2) 230, QM(−4) 232, QM(−6) 234 which may be read from the DRAM 212, the quantized motion output QM(0) 236 which may be written to the DRAM 212 and the de-interlaced output frame DI Out(0) 202 are also described with respect to FIG. 2B.

The two field MCTF 209 may be communicatively coupled with the five field MAD 208. In this regard, the noise reduced interlaced field that may be output from the two field MCTF 209, NR Out(3) 200, may be input to the five field MAD 208 as the interlaced input field In(3) 200. Moreover, the interlaced input field In(1) 222 which may be read from the DRAM 212 may be input to the 2 field MCTF 209 as well as to the five field MAD 208.

The DRAM 212 is described with respect to FIG. 2B. The DRAM 212 may comprise suitable logic, circuitry, interface(s) and/or code that may be operable to store pixel data of a plurality of video fields from the five field MAD 208 and may be operable to retrieve the stored pixel data as needed for de-interlacing processes in the five field MAD 208 as well as the two field MCTF 209.

In operation, the two field MCTF 209 and the five field MAD 208 may be cascaded and/or may be configured to share the DRAM 212. In this regard, the MCTF 209 and the five field MAD 208 may be operable to simultaneously read the same data from the DRAM 212. For example, at a given time instant or for a given processing step, the MCTF 209 may have previously processed In(2) 220, In(1) 222, In(0) 224, and In(−1) 226 and may have previously stored the noise reduced results in the DRAM 212. Also, the five-field MAD 208 may have previously processed the quantized motion QM(−2) 230, QM(−4) 232, QM(−6) 234 and may have previously stored the results in the DRAM 212. The two field MCTF 209 may receive the original interlaced field OIn(3) 207 that may not yet have been noise reduced as well as the previously processed In(1) 222 and may output the noise reduced NR Out(3) 200. The NR Out(3) 200 may be sent to the five field MAD 208 and may simultaneously be sent to the DRAM 212. In this regard, when the output NR Out(3) 200 is input to the five field MAD 208, it may be also referred to as In(3) 200. The five field MAD 208 may also read from the DRAM 212, the previously stored In(2) 220, In(1) 222, In(0) 224, In(−1) 226 and the quantized motion QM(−2) 230, QM(−4) 232, QM(−6) 234. The five field MAD 208 may estimate motion between two or more of the five input fields In(3) 200, In(2) 220, In(1) 222, In(0) 224 and In(−1) 226 and may determine and/or store the quantized motion information QM(0) 236 in the DRAM 212. The five field MAD 208 may utilize the quantized motion information QM(−2) 230, QM(−4) 232, QM(−6) 234 and/or QM(0) 236 to determine a method for interpolating missing pixel data. The five field MAD 208 may determine missing pixel data and may output the de-interlacer frame DI Out(0) 202. It may take time of three fields for an interlaced field input to the two field MCTF 209 to be output from the five field MAD 208 as a de-interlaced frame. In this manner, bandwidth and/or efficiency of the DRAM 212 may be improved. For example, by sharing the DRAM 212 rather than utilizing separate DRAMS for the MCTF 209 and five field MAD 208, only five fields of pixel data rather than seven fields of pixel data may be need to be stored and read.

FIG. 2E is a block diagram illustrating an exemplary configuration for cascading a two field motion compensated temporal filter and a four field motion adaptive de-interlacer, in accordance with an embodiment of the invention. Referring to FIG. 2E, there is shown the two field motion compensated temporal filter (MCTF) 209, an original interlaced field input OIn(2) 248, and a noise reduced output field NR Out(2) 250. In addition, there is shown the four field motion adaptive de-interlacer (MAD) 210, the interlaced input fields In(1) 252, In(0) 254, In(−1) 256, the quantized motion inputs QM(−2) 258, QM(−4) 260, QM(−6) 262, the quantized motion output QM(0) 264 and the de-interlaced frame output DI Out(0) 204. In addition, the DRAM 212 is shown.

The two field motion compensated temporal filter MCTF 209 is described with respect to FIG. 2A. The four field motion adaptive de-interlacer (MAD) 210 is described with respect to FIG. 2C. In addition, the interlaced input fields In(1) 252, In(0) 254, In(−1) 256 which may be read from the DRAM 212, the quantized motion inputs QM(−2) 258 QM(−4) 260, QM(−6) 262 which may be read from the DRAM 212, the quantized motion output QM(0) 264 which may be written to the DRAM 212 and the de-interlaced output frame DI Out(0) 204 are also described with respect to FIG. 2C.

The two field MCTF 209 may be communicatively coupled with the four field MAD 210. In this regard, the noise reduced interlaced field that may be output from the two field MCTF 209, NR Out(2) 250, may be input to the four field MAD 210 as the interlaced input field In(2) 250. Moreover, the interlaced input field In(0) 254 which may be read from the DRAM 212 may be input to the 2 field MCTF 209 as well as to the four field MAD 210.

The DRAM 212 is described with respect to FIG. 2B. The DRAM 212 may comprise suitable logic, circuitry and/or code that may be operable to store pixel data of a plurality of video fields from the four field MAD 210 and may be operable to retrieve the stored pixel data as needed for de-interlacing in the four field MAD 210 as well as the two field MCTF 209.

In operation, the two field MCTF 209 and the four field MAD 210 may be cascaded and/or may be configured to share the DRAM 212. In this regard, the MCTF 209 and the four field MAD 210 may be operable to simultaneously read the same data from the DRAM 212. For example, at an instant in time and/or for a particular processing step, the MCTF 209 may have previously processed In(1) 252, In(0) 254, In(−1) 256 and may have previously stored the noise reduced results in the DRAM 212. Also, the four field MAD 210 may have previously processed the quantized motion QM(−2) 258 QM(−4) 260, QM(−6) 262 and may have previously stored the results in the DRAM 212. Also at the given time instant and/or particular processing step, the two field MCTF 209 may receive the original interlaced field OIn(2) 248 as well as the previously processed In(0) 254 and may output the noise reduced NR Out(2) 250. The NR Out(2) 250 may be sent to the four field MAD 210 and may simultaneously be sent to the DRAM 212. In this regard, when the output NR Out(2) 250 is input to the four field MAD 210, it may be also referred to as In(2) 250. The four field MAD 210 may also read from the DRAM 212, the previously stored In(1) 252, In(0) 254 and In(−1) 256 and the quantized motion QM(−2) 258 QM(−4) 260, QM(−6) 262.

The four field MAD 210 may be operable to estimate motion between two or more of the four input fields In(2) 250, In(1) 252, In(0) 254 and In(−1) 256 and may determine and/or store the quantized motion information QM(0) 264 in the DRAM 212. The four field MAD 210 may utilize the quantized motion information QM(−2) 258 QM(−4) 260, QM(−6) 262 and/or QM(0) 264 to determine a method for interpolating missing pixel data. The four field MAD 210 may determine missing pixel data and may output the de-interlacer frame DI Out(0) 204. It may take two picture delays steps for an interlaced field input to the two field MCTF 209 to be output from the four field MAD 210 as a de-interlaced frame. In this manner, bandwidth and/or efficiency of the DRAM 212 may be improved. For example, when the DRAM is shared, only four fields of pixel data rather than six fields may need to be read from or stored to DRAM memory.

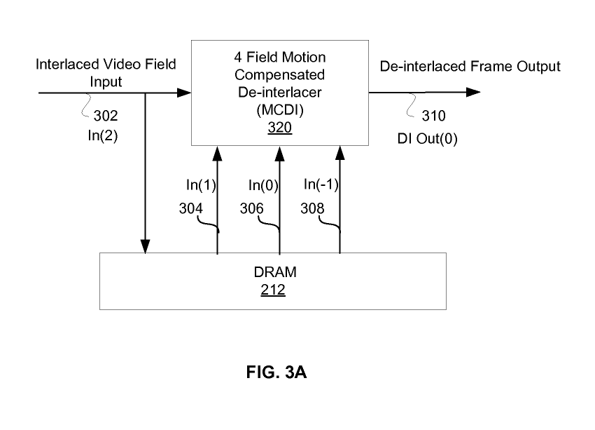

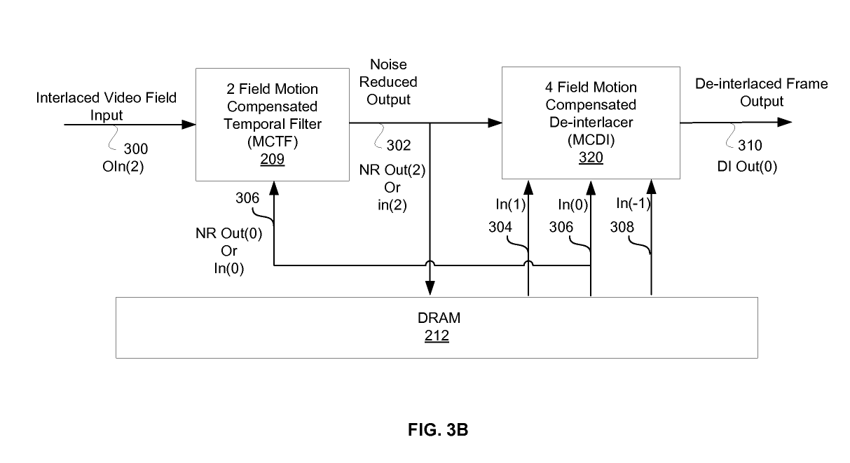

FIG. 3A is a block diagram illustrating an exemplary four field motion compensated de-interlacer, in accordance with an embodiment of the invention. Referring to FIG. 3A, there is shown a four field motion compensated de-interlacer (MCDI) 320, an interlaced field input In(2) 302, three previously input interlaced fields In(1) 304, In(0) 306 and In(−1) 308. In addition, a de-interlaced frame output DI Out(0) 310 is shown.

The motion compensated de-interlacer (MCDI) 320 may comprise suitable logic, circuitry and/or code that may be operable to receive interlaced video fields and output de-interlaced progressive video frames. In this regard, the four field MCDI 320 may be operable to estimate motion between a plurality of video fields and may interpolate missing even lines of pixel data in an odd field and/or interpolate missing odd lines of pixel data in an even field. The four field MCDI 320 may generate progressive video frames that may be displayed at twice the rate as the original scanned interlaced fields. The four field MCDI 320 may utilize searching techniques to estimate motion. For example, the four field MCDI 320 may search one or more nearby fields of the same odd or even polarity and may determine motion of pixelated imagery between the current field and the searched field. The MCDI 320 may determine the direction and/or degree of displacement of the pixelated imagery. The direction and/or degree of motion may be represented by motion vectors. In this regard, the MCDI 320 may determine motion vectors by comparing a reference window of pixel data within a current interlaced field, for example a five by seven window of pixels, with pixel data in a past or future field of same odd or even polarity. Moreover, the MCDI 320 may compare two neighboring fields that may have an opposite odd or even polarity compared to the current field to determine motion vectors and to interpolate missing pixels in the current field. The pixel data within the reference window may be compared to pixel data within a search window comprising the same dimensions that may be displaced to various positions within a specified search range in the past and/or future fields. If a match is found in a previous or future field, the motion vectors may be determined by the displacement of the search window at the position of the match. The MCDI 320 may utilize pixel data from a matched search window of a future and/or previous field to interpolate missing pixel data for a reference window of a current field. The MCDI 320 may determine a weighting factor determining how much information from future and/or previous fields versus how much information from a current field may be utilized to estimate the missing pixel data. In various embodiments of the invention, a linear combination intra-field pixel information and pixel information from one or more other fields may be utilized to estimate missing pixel data.

The DRAM 212 is described with respect to FIG. 2B. The DRAM 212 may comprise suitable logic, circuitry and/or code that may be operable to store pixel data of a plurality of video fields from the four field MCDI 320 and may be operable to retrieve the stored pixel data as needed for motion compensated de-interlacing processes.

The interlaced video input In(2) 302 may be a field of interlaced video at a specified instant in time. The interlaced field In(2) 302 may be input into the four field MCDI 320 and also stored in the DRAM 212. The de-interlacer output frame DI Out(0) 310 may be the result of de-interlacing a field previously input, In(0). In this regard, the de-interlaced output frame DI Out(0) 310 may be delayed by two fields from the time when the original interlaced field In(0) is input to the four-field MCDI 320. The interlaced inputs In(1) 304, In(0) 306 and In(−1) 308 may be previous inputs to the four field MCDI 320 that were stored in the DRAM 212 at the time of their original input into the four field MCDI 320. The previously stored interlaced inputs In(1) 304, In(0) 306 and In(−1) 308 may be read into the four field MCDI 320 for assisting in motion estimation and/or the de-interlacing process for the output frame DI Out(0) 310. In this regard, motion estimation information may be determined by the four field MCDI 320 and/or may be utilized to assist in a de-interlacing process for the output frame DI Out(0) 310.

In operation, the four field MCDI 320 may receive a field of pixel data In(2) 302 and may read three previous inputs In(1) 304, In(0) 306 and In(−1) 308 from the DRAM 212. The four field MCDI 320 may utilize searching techniques and/or motion vectors to estimate motion between two or more of the four input fields In(2) 302, In(1) 304, In(0) 306 and In(−1) 308. The four field MCDI 320 may utilize the estimated motion to determine a method for interpolating missing pixel data in the interlaced fields. The four field MCDI 320 may determine missing pixel data and may output the de-interlacer frame DI Out(0) 310. The DI Out(0) 310 frame may comprise odd and even fields and may be displayed at a rate twice as much the rate of the interlaced fields. In this manner, image resolution may be improved.

FIG. 3B is a block diagram illustrating an exemplary configuration that may enable cascading a two field motion compensated temporal filter and a four field motion compensated de-interlacer, in accordance with an embodiment of the invention. Referring to FIG. 3B, there is shown the two field motion compensated temporal filter (MCTF) 209, an original interlaced field input OIn(2) 300, and a noise reduced output field NR Out(2) 302. In addition, there is shown the four field motion compensated de-interlacer (MCDI) 320, the interlaced input fields In(1) 304, In(0) 306, In(−1) 308 and the MCDI de-interlaced frame output DI Out(0) 310. In addition, the DRAM 212 is shown.

The two field motion compensated temporal filter MCTF 209 is described with respect to FIG. 2A. The four field MCDI 320 is described with respect to FIG. 3A. In addition, the previously input interlaced fields In(1) 304, In(0) 306, In(−1) 308 which may be read from the DRAM 212 and the de-interlaced output frame DI Out(0) 310 are also described with respect to FIG. 3A.

The two field MCTF 209 may be communicatively coupled to the four field MCDI 320. In this regard, the noise reduced interlaced field that may be output from the two field MCTF 209, NR Out(2) 302, may be input to the four field MCDI 320 and may be referred to as the interlaced input field In(2) 302. Moreover, the interlaced input field In(0) 306 which may be read from the DRAM 212 may be simultaneously input to the two field MCTF 209 as well as to the four field MCDI 320.

The DRAM 212 is described with respect to FIG. 2B. The DRAM 212 may comprise suitable logic, circuitry and/or code that may be operable to store pixel data of a plurality of video fields output from the two field MCTF 209 and may be operable to retrieve the stored pixel data as needed for de-interlacing processes in the four field MCDI 320 as well as the two field MCTF 209.

In operation, the two field MCTF 209 and the four field MCDI 320 may be cascaded and/or may be configured to share the DRAM 212. In this regard, the MCTF 209 and the four field MCDI 320 may be operable to simultaneously read the same data from the DRAM 212. For example, at a particular time instant or for a particular process step, the MCTF 209 may have previously processed In(1) 304, In(0) 306, In(−1) 308 and may have previously stored the noise reduced results in the DRAM 212. At the particular time instant or the particular process step, the two field MCTF 209 may receive the original interlaced field OIn(2) 300 as well as the previously processed In(0) 306 from the DRAM 212 and may output the noise reduced NR Out(2) 302. The NR Out(2) 302 may be sent to the four field MCDI 320 and may simultaneously be sent to the DRAM 212. In this regard, when the output NR Out(2) 302 is input to the four field MCDI 320, it may be also referred to as In(2) 302.

The four field MCDI 320 may also read from the DRAM 212, the previously stored In(1) 304, In(0) 306, In(−1) 308. The four field MCDI 320 may estimate motion between two or more of the four input fields In(2) 302, In(1) 304, In(0) 306, In(−1) 308 and may determine a method for interpolating missing pixel data. The four field MCDI 320 may determine missing pixel data and may output the de-interlacer frame DI Out(0) 310. It may take two picture delays or process steps for an interlaced field input to the two field MCTF 209 to be output from the four field MCDI 320 as a de-interlaced frame. In this manner, bandwidth and/or efficiency of the DRAM 212 may be improved. For example, when the DRAM is shared, only four fields of pixel data rather than six fields of pixel data may need to be read from or stored to DRAM memory.

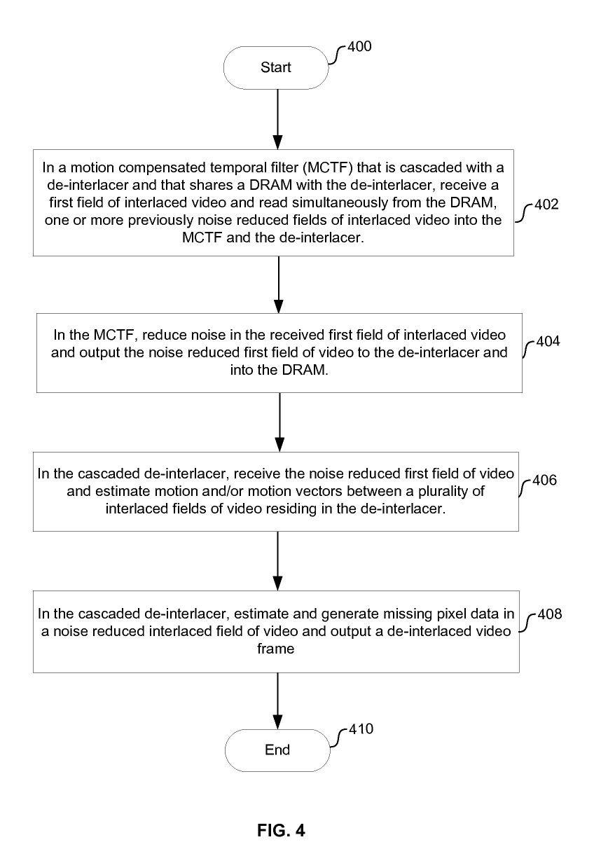

FIG. 4 illustrates exemplary steps for reducing noise and de-interlacing fields of interlaced video utilizing a shared DRAM, in accordance with an embodiment of the invention. Referring to FIG. 4, the exemplary steps may begin with start step 400. In step 402, a motion compensated temporal filter (MCTF) 209 that may be cascaded with a de-interlacer, for example, the four field motion adaptive de-interlacer (MAD) 210, the five field MAD 208 and/or a four field motion compensated de-interlacer (MCDI) 320. The MCTF 209 may share the DRAM 212 with the de-interlacer. The MCTF 209 may receive a first field of interlaced video and may read from the DRAM, simultaneously with the de-interlacer, one or more previously noise reduced fields of interlaced video. In step 404, in the MCTF 209, noise may be reduced in the received first field of interlaced video and the noise reduced first field of video may be output to the de-interlacer and into the DRAM 212. In step 406, in the cascaded de-interlacer, receive the noise reduced first field of video and estimate motion and/or motion vectors between a plurality of interlaced fields of video residing in the de-interlacer. In step 408, estimate and generate missing pixel data in a noise reduced interlaced field of video and output a de-interlaced video frame. The exemplary steps may end with step 410.

In an embodiment of the invention, a video processing system may comprise a motion compensated filter 209 and a de-interlacer, for example, the motion adaptive de-interlacer (MAD) 210, and a memory, for example, the DRAM 212, which is shared by the motion compensated filter 209 and a de-interlacer 210. The motion compensated filter 209 may be a motion compensated temporal filter. The motion compensated filter 209 and/or the de-interlacer 210 may be operable to read one or more fields of noise reduced pixel data, for example, In(0) 254 from the shared memory 212. The de-interlacer 210 may convert a noise reduced current field of pixel data to a de-interlaced frame of pixel data utilizing the one or more fields of noise reduced pixel data read from the shared memory 212. In this regard, the motion compensated filter 209 may estimate motion and/or motion vectors between two or more fields of pixel data. Based on the estimated motion and/or motion vectors, the motion compensated filter 209 may determine a method for replacing noisy pixel data and may generate pixel data to replace the noisy pixel data. Once a current field of pixel data may be noise reduced, the motion compensated filter 209 may communicate the noise reduced current field of pixel data to the shared memory 212 and to the de-interlacer 210.

The de-interlacer 210 may be operable to read the current field of noise reduced pixel data and may read one or more fields of noise reduced pixel data from the shared memory 212, for example, In(1) 252, In(0) 254 and In(−1) 256. The de-interlacer 210 may estimate motion and/or motion vectors between two or more fields of noise reduced pixel data based on motion compensation and/or motion adaptive techniques and may write quantized estimated motion, for example, QM(0) 264 to the shared memory 212. In this regard, motion may be estimated by searching for matching pixel data at one or more displaced positions within one or more of said fields of noise reduced pixel data. Based on the estimated motion, the de-interlacer 210 may determine a method for estimating missing pixel data. The de-interlacer 210 may also read two or more quantized motion estimates from the shared memory 212, for example, QM(−2) 258, QM(−4) 260 and QM(−6) 262. Pixel data that may be missing from the interlaced frame may be generated by the de-interlacer 210.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for integrated video noise reduction and de-interlacing.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video data, the method comprising:
in a video processing system comprising one or both of a motion compensated filter and a de-interlacer, wherein said one or both of said motion compensated filter and said de-interlacer share a memory:
reading one or more fields of noise reduced pixel data by said one or both of said motion compensated filter and said de-interlacer one time from said shared memory;
replacing a noisy current field of pixel data by a noise reduced current field of pixel data utilizing said read one or more fields of noise reduced pixel data; and
converting a noise reduced current field of pixel data to a de-interlaced frame of pixel data utilizing said read one or more fields of noise reduced pixel data.

2. The method according to claim 1, comprising estimating motion and/or motion vectors between two or more fields of pixel data.

3. The method according to claim 2, comprising determining a method for estimating pixel data to replace noisy pixel data based on said estimated motion and/or motion vectors.

4. The method according to claim 1, comprising generating pixel data to replace noisy pixel data of said current field of pixel data.

5. The method according to claim 1, comprising sending said noise reduced current field of pixel data to said shared memory and to said de-interlacer.

6. The method according to claim 1, comprising receiving said current field of noised reduced pixel data from said motion compensated filter and reading one or more of said fields of noise reduced pixel data from said shared memory.

7. The method according to claim 1, comprising estimating motion and/or motion vectors between two or more fields of noise reduced pixel data based on one or both of motion compensated de-interlacing and motion adaptive de-interlacing.

8. The method according to claim 1, comprising writing quantized estimated motion to said shared memory.

9. The method according to claim 1, comprising reading two or more quantized estimated motion from said shared memory.

10. The method according to claim 1, comprising determining a method for estimating missing pixel data within ones of said fields of noise reduced pixel data based on said estimated motion and/or motion vectors.

11. The method according to claim 1, comprising generating pixel data that is missing from said interlaced field.

12. The method according to claim 1, wherein said motion compensated filter comprises a temporal motion compensated filter.

13. The method according to claim 1, wherein said de-interlacer comprises a motion compensated de-interlacer and/or a motion adaptive de-interlacer.

14. A system for processing video data, the system comprising:
one or more circuits for use in a video processing system, said one or more circuits comprising a memory, and one or both of a motion compensated filter and a de-interlacer, and said one or both of said motion compensated filter and said de-interlacer share said memory, wherein said one or more circuits are operable to:
read one or more fields of noise reduced pixel data by said one or both of said motion compensated filter and/or said de-interlacer one time from said shared memory;
replace a noisy current field of pixel data by a noise reduced current field of pixel data utilizing said read one or more fields of noise reduced pixel data; and
convert a current field of noise reduced pixel data to a de-interlaced frame of pixel data utilizing said read one or more fields of noise reduced pixel data.

15. The system according to claim 14, wherein said one or more circuits are operable to estimate motion and/or motion vectors between two or more fields of pixel data.

16. The system according to claim 15, wherein said one or more circuits are operable to determine a method for estimating pixel data to replace noisy pixel data based on said estimated motion and/or said motion vectors.

17. The system according to claim 14, wherein said one or more circuits are operable to generate pixel data to replace noisy pixel data of said current field of pixel data.

18. The system according to claim 14, wherein said one or more circuits are operable to send said noise reduced current field of pixel data to said shared memory and to said de-interlacer.

19. The system according to claim 14, wherein said one or more circuits are operable to receive said current field of noised reduced pixel data from said motion compensated filter and read one or more of said fields of noise reduced pixel data from said shared memory.

20. The system according to claim 14, wherein said one or more circuits are operable to estimate motion and/or motion vectors between two or more fields of noise reduced pixel data based on one or both of motion compensated de-interlacing and motion adaptive de-interlacing.

21. The system according to claim 14, wherein said one or more circuits are operable to write quantized estimated motion to said shared memory.

22. The system according to claim 14, wherein said one or more circuits are operable to read two or more quantized estimated motion from said shared memory.

23. The system according to claim 14, wherein said one or more circuits are operable to determine a method for estimating missing pixel data within ones of said fields of noise reduced pixel data based on estimated motion and/or motion vectors.

24. The system according to claim 14, wherein said one or more circuits are operable to generate pixel data that is missing from said interlaced field.

25. The system according to claim 14, wherein said motion compensated filter comprises a temporal motion compensated filter.

26. The system according to claim 14, wherein said de-interlacer comprises a motion compensated de-interlacer and/or a motion adaptive de-interlacer.
